(19) United States
(12) Patent Application Publication
(10) Pub. No.: US 2007/0273240 A1
(43) Pub. Date: Nov. 29, 2007

(54) System for and method of rotating wheels in rotary air-to-air energy recovery and desiccant dehumidification systems

(76) Inventors: Donald F. Steele, Cohasset, MA (US); Edward C. Lovelace, Arlington, MA (US); Roger B. Dickinson, Torrington, CT (US)

Correspondence Address: MCDERMOTT WILL & EMERY LLP, 28 STATE STREET, BOSTON, MA, 02109-1775, US

(21) Appl. No.: 11/655,421

(22) Filed: Jan. 19, 2007

Related U.S. Application Data
(60) Provisional application No. 60/760,287, filed on Jan. 19, 2006.

(51) Int. Cl. H02K 1/12

(52) U.S. Cl. 310/258; 310/152; 310/40 R

(57) ABSTRACT

A system for and method of rotating a transfer wheel providing heat and/or moisture exchange between two counter-flowing air streams. The system comprises: a frame; a transfer wheel including a transfer matrix mounted and rotationally secured relative to the frame so that the wheel can rotate through the two counter-flowing air streams and heat and/or moisture can be transferred between the two counter-flowing air streams; and a first plurality of motor components fixedly mounted relative to the wheel so that components of the first plurality function as a rotor of a motor, and a second plurality of motor components fixedly mounted relative to the frame so that components of the second plurality function as a stator of a motor; wherein power supplied to motor components of the second plurality causes the transfer wheel to rotate through the two counter-flowing air streams.

### RELATED APPLICATIONS

The present application is related to and claims priority from U.S. Provisional Patent Application 60/760,287 filed Jan. 19, 2006.

### FIELD

The present disclosure relates generally to energy and moisture transfer wheels and, more particularly, to improvements in systems for methods of controlling the rotation of such wheels in rotary air-to-air energy recovery and in active and passive humidification and dehumidification systems.

### BACKGROUND

Energy and moisture transfer wheels are well known for effecting the transfer of heat and/or moisture between two counter-flowing air streams. Such transfer wheels are typically used to control the temperature and/or humidity of air within buildings, wherein the counter-flowing air streams can be incoming and outgoing air.

A drive motor is usually mounted adjacent to and coupled with a pulley and a drive belt to the transfer wheel so that the wheel can be rotationally driven about its axis during operation. Further, the drive motor is usually selected from a large group that are typically employed for such applications, the particular selection depending on various factors such as the size and weight of the wheel, and the available building power supplies that can range from 120 to 575 VAC with frequencies typically of 50 Hz or 60 Hz, single phase or three phase.

Accordingly, it is desirable to provide a single motor that can operate within the full range of expected power supplies and operating frequencies, as well as provide variable rotational speeds as needed.

### SUMMARY

A system for and method of rotating a transfer wheel providing heat and/or moisture exchange between two counter-flowing air streams. The system comprises: a frame; a transfer wheel including a transfer matrix mounted and rotationally secured relative to the frame so that the wheel can rotate through the two counter-flowing air streams and heat and/or moisture can be transferred between the two counter-flowing air streams; and a first plurality of motor components fixedly mounted relative to the wheel so that motor components of the first plurality function as a rotor of a motor, and a second plurality of motor components fixedly mounted relative to the frame so that components of the second plurality function as a stator of the motor; wherein power supplied to motor components of the second plurality causes the transfer wheel to rotate through the two counter-flowing air streams.

### GENERAL DESCRIPTION OF THE DRAWINGS

Reference is made to the attached drawings, wherein elements having the same reference character designations represent like elements throughout, and wherein:

FIG. 1 shows side view, in cross-section of a counter-flow heat exchanger disposed within a counter-flow heat and/or moisture exchange system disposed within a counter-flow air system;

FIG. 2 is a frontal view of the frame and wheel of the counter-flow heat and/or moisture exchange system;

FIG. 3 is a perspective view of an assembled brushless DC motor arrangement for use in the counter-flow heat and/or moisture exchange system;

FIG. 4 is an exploded view of the motor arrangement of FIG. 3;

FIG. 5 is front view of a stepper motor arrangement for the counter-flow heat and/or moisture exchange system; and

FIGS. 6A-6C are perspective, side and frontal views of a pole piece assembly used in the stepper motor arrangement illustrated in FIG. 5.

### DETAILED DESCRIPTION OF THE DRAWINGS

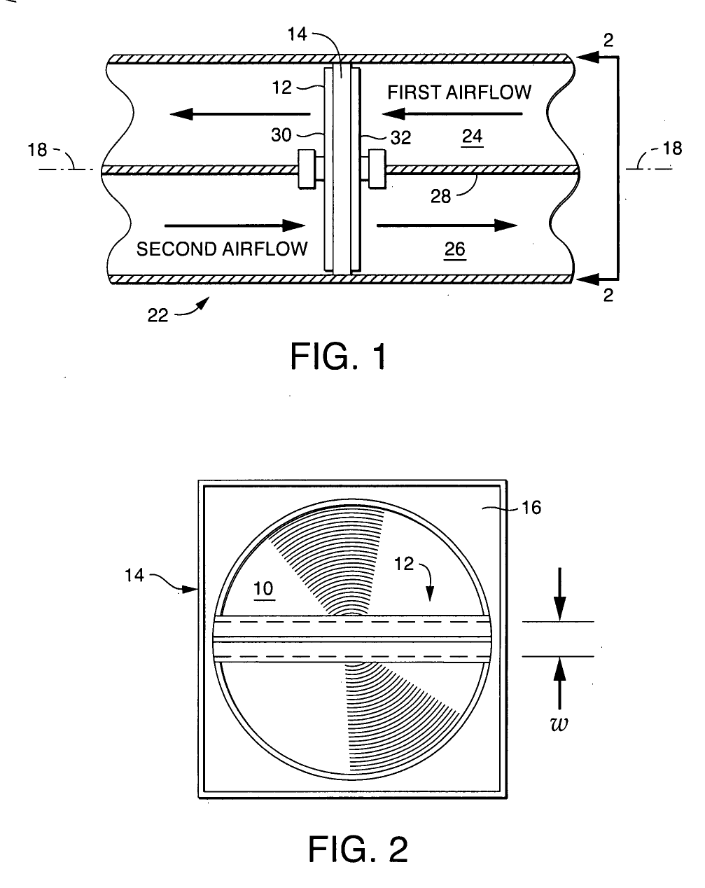

Referring to FIGS. 1 and 2, the present disclosure provides a heat and/or moisture transfer matrix 10 for use as part of a heat and/or moisture transfer wheel 12 in a counter-flow heat and/or moisture exchange system 14. The transfer wheel 12 is rotationally mounted about rotation axis 18 within a frame 16. The transfer matrix 10 is constructed with narrow air passageways so as to transfer heat and moisture between two counter-flowing air streams. The transfer matrix 10 can further include one or more desiccant materials for enhancing the moisture transfer from the more humid air to the drier air. Frame 16 includes a single seal plate, or multiple plate pieces substantially surrounding the transfer wheel 12 so that substantially all of the air of the counter-flowing air streams will pass through the transfer matrix.

As shown in FIGS. 1 and 2, the exchange system 14 is disposed with an air flow system 22. System 22 can include a flow duct 24 and a counter-flow duct 26 separated by a wall(s) 28. A first airflow is received by the flow duct 24, while a second airflow is received by the counter-flow duct 26. As their names imply, the flow and counter-flow ducts 24, 26 direct airflows in opposite directions through the wheel 12. One airflow is warmer and/or more humid than the other, so that as the wheel turns some of the heat and/or moisture is transferred by the wheel. Alternatively, the air flow system can include a cabinet designed to have two counter-flowing air streams pass through the cabinet, and constructed so that the transfer wheel 12 and frame 16 can be mounted therein.

The transfer wheel 12 is mounted within the air flow system 22 for simultaneous rotation through the flow duct 24 and the counter-flow duct 26, with an outer circumference of the wheel 12 forming a nearly air-tight seal between the wheel 12 and the frame 16 so as to insure flow through the matrix, and between the flow and counter-flow ducts 24 and 26 so as to prevent leakage between the ducts 24 and 26. A seal around the perimeter of the wheel insures that air flows through the matrix as the wheel rotates.

The narrow air passageways of transfer matrix 10 of transfer wheel 12 extend between the faces 30 and 32 of the wheel 12. Accordingly, the first airflow passes through the wheel 12 from the second face 32 to the first face 30, while the second airflow passes through the wheel 12 from the first face 30 to the second face 32. As the wheel rotates heat and/or moisture can be exchanged between the two airflows.

In accordance with the teachings of the present disclosure, a separate drive motor, belt and pulley are eliminated, and the transfer wheel 12 and frame 16 are configured and arranged so as to include motor components fixedly mounted relative to each of the wheel 12 and frame 16 so that motor components fixed relative thereto function as a rotor of a motor, while motor components fixed relative to the frame function as a stator of a motor. When power is supplied to stator motor components, the wheel 12 is caused to rotate through the two counter-flowing air streams.

The motor components employed will depend on the motor design. Preferably, motor components secured relative to the wheel 12 function as the rotor, and motor components secured relative to the frame 16 function as a stator. The stator is preferably only actuated on a portion of the full 360 degree wheel circumference using one or more stator electromagnetic pole segments or pieces. This can also be referred to as an “incomplete” stator or stator segment. There are many types of designs for such motors. For example, the brushless motor design can take the form of a brushless DC motor with sensors, a DC motor without sensors or a DC stepper motor, which is a form of brushless DC motor. All such motors use an electronic controller for performing a desired power distribution. One controller suitable for providing such control is the MC33033, NCV 33033 manufactured by On Semiconductor. See Brushless DC Motor Controller, Publication Order Number: MC 33033/D, April, 2004, Rev. 7, published by On Semiconductor, pages 1-24.

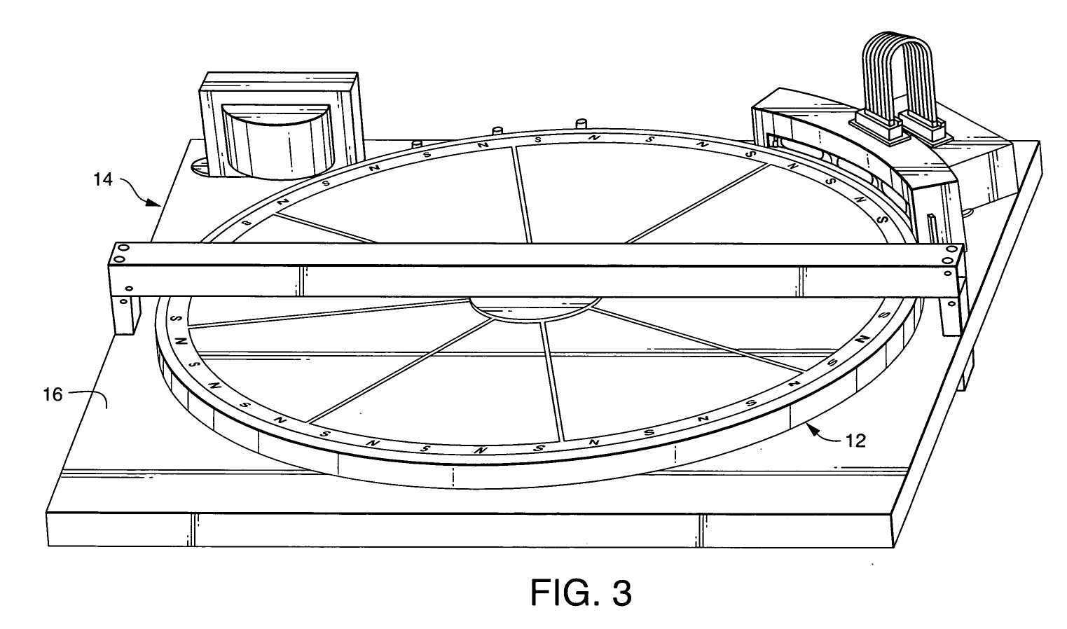

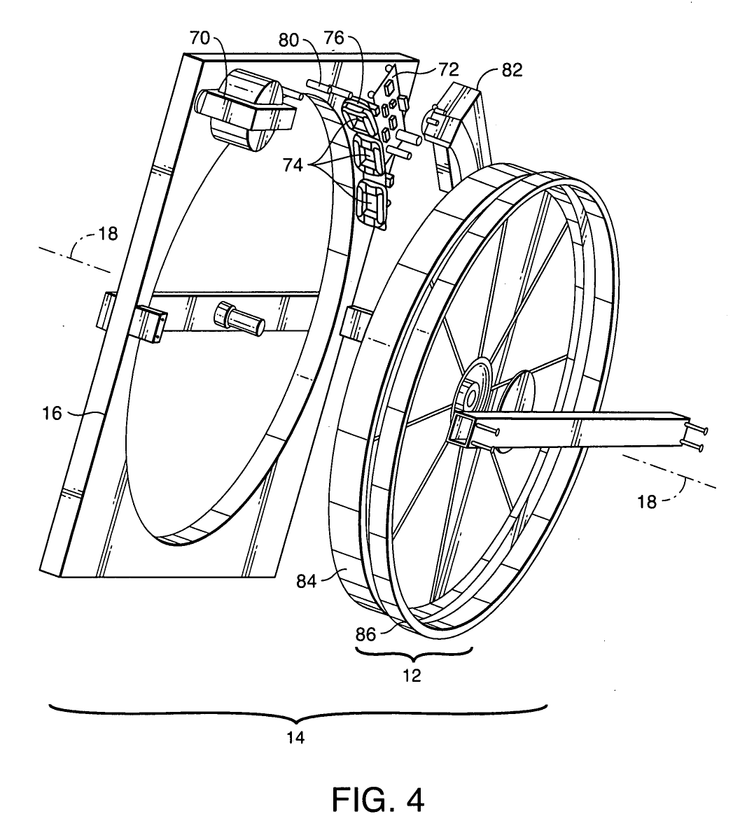

FIGS. 3 and 4 show one embodiment of the wheel 12 and frame 16 of counter-flow exchange system 14. The system is modified to include motor components so as to provide brushless DC motor operation. Specifically, the wheel 12 is modified to include a first plurality of motor components fixed relative to the wheel so that components of the first plurality can function as the rotor of a brushless DC motor, while a second plurality of motor components are fixed relative to the frame so that components of the second plurality function as a stator of that motor. A power converter 70 (including a transformer, if necessary) is provided for converting the available power to conform to suitable power parameters for driving the wheel 12. The power converter is shown secured to the frame 16, although it can be secured elsewhere. Further, a commutation controller 72 is similarly provided and is shown attached to the frame 16. The stator coils 74 and a back iron assembly 76 are secured relative to the frame 16. At least three stator coils 74 are used, and they are secured to the frame 16 so that the three coils 74 are positioned adjacent the rim of the wheel 12. A cover 82 is used to cover the commutation controller 72 and coils 74. Finally, a plurality of commutation sensors 80 are secured relative to the frame 16 for sensing the position of the wheel 12 as it rotates on its axis 18. The sensors 80 can be mounted so that they are spaced from the stator coils 74 as shown, or in between or among the coils 74, as desired. The sensors 80 can also be eliminated when employing a brushless DC motor design without sensors, as further described below. Further, for large wheels, additional sets of stator coils 74 can be employed to provide additional torque. Preferably, at least three such sensors are provided when implementing a three phase motor arrangement, and at least two such sensors are used when implementing a four phase motor arrangement.

The wheel 12 shown in FIGS. 3 and 4 is also modified to include motor components. Preferably, in order to function as a brushless DC motor, the wheel is preferably provided with a continuous base strip 84 in the form of a back iron or similar ferromagnetic material disposed continuously around the rim of the wheel, and a flexible segmented armature magnet strip 86 for providing a plurality of permanent magnetic sections distributed around the rim. Alternative to the strip 86, the wheel can be provided with a plurality of separate permanent magnets distributed around the rim. The base strip 84 provides a magnet path for the magnetic strip or permanent magnets. As best seen in FIG. 3, the magnetic strip 86 (or if the alternative arrangement of permanent magnets is used) provides a electromagnetic pattern of alternating north and south poles as one progresses around the rim of the wheel 12 (as best seen in FIG. 3).

In operation, the external power is delivered to power converter 70, which in turn provides the appropriate power within appropriate parameters to the controller 72. The controller 72 provides the necessary drive signals to the stator coils 74 so as to create a pulsing flux field through the rim of the wheel, and in particular to the magnetic strip 86 and base strip 84. This creates an electromagnetic force (EMF) causing the wheel to rotate. The controller 72 can be provided with an input so that the rotational speed of the wheel can be easily controlled, accommodating substantially all anticipated modes of operation of the exchange system, and assuring no rotation when rotation is not desired.

Brushless DC motors of the type using sensors, and those without sensors are described at http://en.wikipedia.org/wiki/Brushless_DC_electric_motor (Jan. 12, 2007). As indicated the controller is used to direct the rotor rotation. For the design using sensors, the controller uses a communation sensor arrangement to determine the rotor's orientation/position (relative to the stator coils). Some designs use Hall effect sensors, but one can also use other arrangements such as a rotary encoder to directly measure the rotor's position. Other designs measure the back EMF in the undriven coils to infer the rotor position, eliminating the need for separate commutation sensors, and therefore are often called “sensorless” controllers.

A typical controller of the brushless DC motor of both the sensor type and the sensorless type contains 3 bi-directional drivers for driving high-current DC power. The drivers are usually controlled by a logic circuit. Simple controllers employ comparators to determine when the output phase should be advanced, while more advanced controllers employ a microcontroller for managing acceleration, control speed and fine-tune efficiency. Controllers for the sensorless DC motors that sense rotor position based on back-EMF have extra challenges in initiating motion because no back-EMF is produced when the rotor is stationary. This is usually accomplished by beginning rotation from an arbitrary phase, and then skipping to the correct phase if it is found to be wrong. This can cause the motor to run briefly backwards, adding even more complexity to the startup sequence.

Brushless DC motors can be constructed in several different physical configurations: In the ‘conventional’ (also known as ‘inrunner’) configuration, the permanent magnets are mounted on the spinning armature (rotor). Multiple stator windings are provided adjacent to the wheel. The number of windings is dependent upon the number of phases and power required.

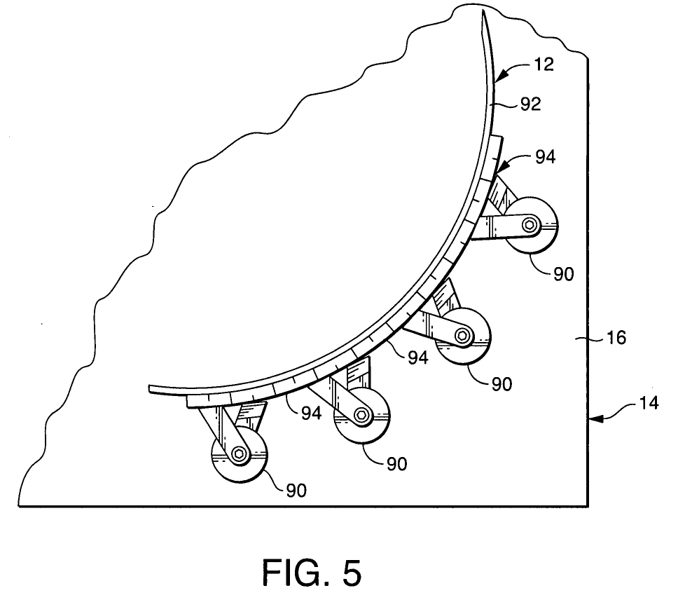

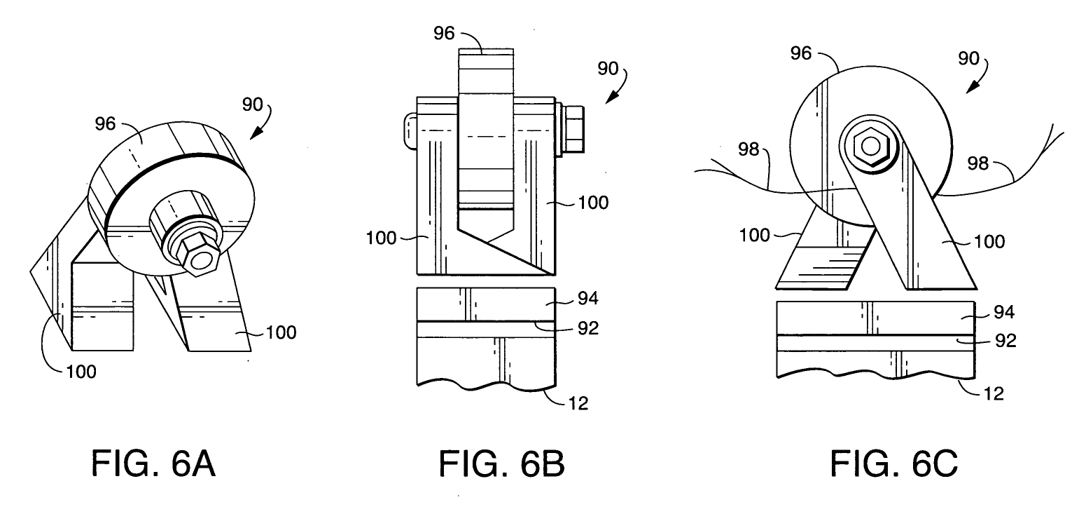

As described the brushless motor design used in the modified exchange system 14 can be that of a stepper motor. An embodiment of the counter-flow heat exchanger configured as a stepper motor is illustrated in FIG. 5, wherein frame 16 supports the coil and pole piece assemblies 90, and the wheel 12 supports the continuous backiron (made of ferromagnetic material) base strip 92 and magnetic strip 94 (or alternatively the permanent magnets). The polarity of the magnetic strip (or the alternate magnets) alternates between a north and south pole around the rim of the wheel. The coil and pole piece assemblies are illustrated in greater detail in FIGS. 6A-6C. As shown, each assembly 90 includes a center coil 96 with lead wires 98. the coils 96 is disposed between the two pole teeth 100, which when mounted on the frame 16 are radial displaced from one another. The pole teeth and alternating polarities of the magnetic strip (or the alternate magnets) are offset, so that all the teeth will not be aligned with all of the north and south polarties of the magnetic strip (or the alternate magnets) at any one time. AC signals can be applied from a suitable power converter (not shown) to the coils 96.

As described at http://en.wikipedia.org/wiki/Stepper_motor (Jan. 12, 2007), stepper motors operate differently from brushless DC motors with sensors. Brushless DC motors with sensors simply spin when voltage is applied to the driving coils on the stator. Stepper motors, on the other hand, effectively have multiple electromagnets arranged around a central rotor. To make the motor shaft turn, first one electromagnet is given power through a coil and pole piece arrangement provided on the stator, which makes the rotor rotate by a predetermined angular increment. When the magnetic fields created on the stator pole pieces are aligned with the fields provided on the rotor, they are slightly offset from the next electromagnet. So when the next electromagnet is turned on and the first is turned off, the rotor rotates slightly to align with the next one, and from there the process is repeated so as to effect rotation. Each of those slight rotations is called a “step.” In that way, the motor can be turned a precise angular increments, or by applying a AC drive signal to the coils provided on the stator, the rotor can be continuously rotated. There are two basic arrangements for the electromagnetic coils of a stepper motor: bipolar and unipolar.

A stepper motor can be viewed as a DC motor with the number of poles (on both rotor and stator) increased, taking care that they have no common denominator. Additionally, soft magnetic material with many teeth on the rotor and stator cheaply multiplies the number of poles (reluctance motor). It is ideally driven by sinusoidal current, allowing a stepless operation. Pulse-width modulatoin is typically used to regulate the mean current. Bipolar controllers can switch between supply voltage, ground, and unconnected. Unipolar controllers can only connect or disconnect a cable, because the voltage is already hard wired. Unipolar controllers need center-tapped windings. To achieve full rated torque, the coils in a stepper motor must reach their full rated current during each step.

Thus, a new and improved heat and/or moisture exchange system and method provided in accordance with the present disclosure have been described. The exemplary embodiment described in this specification have been presented by way of illustration rather than limitation, and various modifications, combinations and substitutions may be effected by those skilled in the art without departure either in spirit or scope from this disclosure in its broader aspects and as set forth in the appended claims. Thus, providing motor components to the wheel 12 and frame 16 of a counter-flow heat and/or moisture exchange system eliminates the need for a drive motor, belt and pulley. Further, fewer design choices are necessary to cover all of the potential applications, including the range of possible wheel sizes and power sources. In addition, the wheel 12 can be better controlled from zero to the fully rated rpm.

The new and improved heat exchange system and method of the present disclosure as disclosed herein, and all elements thereof, are contained within the scope of at least one of the following claims. No elements of the presently disclosed system and method are meant to be disclaimed, nor are they intended to necessarily restrict the interpretation of the claims. In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for providing heat and/or moisture exchange between two counter-flowing air streams, comprising:
a frame;
a transfer wheel including a transfer matrix mounted and rotationally secured relative to the frame so that the wheel can rotate through the two counter-flowing air streams and heat and/or moisture can be transferred between the two counter-flowing air streams; and
a first plurality of motor components fixedly mounted relative to the wheel so that motor components of the first plurality function as a rotor of a motor, and a second plurality of motor components fixedly mounted relative to the frame so that components of the second plurality function as a stator of a motor;
wherein power supplied to motor components of the second plurality causes the transfer wheel to rotate through the two counter-flowing air streams.

2. A system according to claim 1, wherein motor components of the first plurality are configured so as to function as a rotor, and motor components of the second plurality are configured so as to function as a stator of a brushless motor.

3. A system according to claim 1, wherein the motor components include permanent magnets.

4. A system according to claim 3, wherein the second plurality of motor components include stator field coils configured and mounted relative to the frame.

5. A system according to claim 1, wherein components of the first plurality of motor components are configured so as to function as a rotor, and components of the second plurality of motor components are configured so as to function as a stator of a brushless DC motor with sensors.

6. A system according to claim 1, wherein components of the first plurality of motor components are configured so as to function as a rotor, and components of the second plurality of motor components are configured so as to function as a stator of a brushless DC motor without sensors.

7. A system according to claim 1, wherein components of the first plurality of motor components are configured so as to function as a rotor, and components of the second plurality of motor components are configured so as to function as a stator of a stepper motor.

8. A system according to claim 1, wherein the transfer matrix is used to transfer moisture between counter-flowing air streams so as to enhance humidification of one of the air streams.

9. A system according to claim 1, wherein the transfer matrix is used to transfer moisture between counter-flowing air streams so as to reduce humidification of one of the air streams.
